(19) United States
(12) Patent Application Publication
(10) Pub. No.: US 2024/0380710 A1
(43) Pub. Date: Nov. 14, 2024

(54) NETWORK DEVICE AND DATA UPLOADING METHOD THEREOF

(71) Applicant: Realtek Singapore Private Limited, Singapore (SG)

(72) Inventor: Florin Daniel APETREI, San Jose, CA (US)

(21) Appl. No.: 18/354,089

(22) Filed: Jul. 18, 2023

Related U.S. Application Data
(60) Provisional application No. 63/464,948, filed on May 9, 2023.

(51) Int. Cl. H04L 49/90; H04L 47/36

(52) U.S. Cl. CPC H04L 49/90; H04L 47/36

(57) ABSTRACT

A data uploading method which applies to a network device, and the network device includes a page queue. The data uploading method includes: receiving an authorization message, the authorization message includes an authorization size; executing an upload procedure to obtain an upload queue, and the upload procedure includes: executing the page queue upload procedure according to the page queue and the authorization size to obtain a first authorization remaining size and a continuation page number; executing a remaining queue upload procedure according to the first authorization remaining size, the continuation page number and a remainder parameter to obtain a continuation packet number and a second authorization remaining size; and executing a packet upload procedure according to the continuation packet address and the second authorization remaining size; and uploading the packet data stored in the upload queue through the network device.

### CROSS-REFERENCE TO RELATED APPLICATION

This application claims the benefit of U.S. provisional application Ser. No. 63/464,948, filed on May 9, 2023. The entirety of the above-mentioned patent application is hereby incorporated by reference herein and made a part of the specification.

### BACKGROUND

### Technical Field

The present invention relates to a communication data transmission technology, and in particular relates to a network device and a data uploading method thereof.

### Related Art

Generally, communication transmission includes uplink transmission and downlink transmission. In point-to-multipoint communication transmission (for example, a passive optical network (PON)), the downlink transmission is to continuously send data to multiple network units by a line terminal. The uplink transmission is that the multiple network units send data to the line terminal. The passive optical network is an optics communication network consisting of an optical line terminal (OLT), an optical network unit (ONU) and an optical distribution network (ODN).

Generally, the line terminal will send an allowable upload data size and allocate a time slot to each network unit during downlink transmission. Each network unit can only upload data of the allowable upload data size in the time slot allocated by the line terminal. Conventionally, each network unit works out the data that conforms to the allowable upload data size packet by packet according to stored packets thereof within a time period from a time point when information such as the allowable upload data size and the allocated time slot from the line terminal is received to a start time point of the allocated time slot, and uploads the data that conforms to the allowable upload data size in the allocated time slot. However, as the time period from the time point when the information such as the allowable upload data size and the allocated time slot from the line terminal is received to the start time point of the allocated time slot becomes shorter and shorter, the network unit works out the data that conforms to the allowable upload data size packet by packet according to the stored packets thereof, which may make the network unit unable to work out all the data that conforms to the allowable upload data size within this time period, so that there is a huge drop between the data size uploaded in the allocated time slot and the allowable upload data size, thereby resulting in waste of efficiency. Therefore, how the network unit can quickly work out the data that conforms to the allowable upload data size within this time period to increase the efficiency of a whole data transmission technology is a problem that urgently needs to be overcome.

### SUMMARY

In one embodiment, a data uploading method is provided, which applies to a network device. The network device includes a page queue. The data uploading method includes: receiving an authorization message, the authorization message includes an authorization size; executing an upload procedure to obtain an upload queue, and the upload procedure includes: executing the page queue upload procedure according to the page queue and the authorization size to obtain a first authorization remaining size and a continuation page number; executing a remaining queue upload procedure according to the first authorization remaining size, the continuation page number and a remainder parameter to obtain a continuation packet number and a second authorization remaining size; and executing a packet upload procedure according to the continuation packet number and the second authorization remaining size; and uploading the packet data stored in the upload queue through the network device.

In one embodiment, a data uploading method is provided, which applies to a network device. The network device includes a page queue. The data uploading method includes: receiving an authorization message, the authorization message includes an authorization size; executing an upload procedure to obtain an upload queue, and the upload procedure includes: executing the page queue upload procedure according to the page queue and the authorization size to obtain a first authorization remaining size and a continuation page number; executing a remaining queue upload procedure according to the first authorization remaining size, the continuation page number and a remainder parameter to obtain a continuation packet number and a second authorization remaining size; and executing a packet upload procedure according to the continuation packet number and the second authorization remaining size; and uploading the packet data stored in the upload queue through the network device. The page queue upload procedure includes: obtaining a start page number according to the page queue, the page queue includes multiple sequential page records, the start page number corresponds to one of the multiple page records, and each page record includes a page size and an auxiliary queue, the auxiliary queue includes multiple sequential packets corresponding to the page record, and the page size is a sum of the data sizes of the multiple packets corresponding to the page record; storing data of the packets corresponding to the page record corresponding to the start page number and continuation page records thereof to the upload queue page by page, and summing the page sizes of the page record corresponding to the start page number and the continuation page records thereof to calculate a first summation result, and determining whether the first summation result meets a first stop condition or not after working out the first summation result page by page, the first stop condition is that the authorization size minus the first summation result is less than the page size; when the first stop condition is met, taking the first summation result as a first upload size, and subtracting the first upload size from the authorization size to obtain a first authorization remaining size; and obtaining the continuation page number according to a page record that follows the last page record in the first summation result. The remaining queue upload procedure includes: subtracting a remainder derived from the first authorization remaining size divided by the remainder parameter from the first authorization remaining size to obtain a second upload size; storing data of part of packets corresponding to the page record corresponding to the continuation page number to the upload queue according to the continuation page number and the second upload size, a sum of data sizes of the part of packets corresponding to the page record corresponding to the continuation page number stored to the upload queue is equal to the second upload size; obtaining a start packet number according to an auxiliary queue of the page record corresponding to the continuation page number, the start packet number corresponds to one of multiple packets, and each packet includes data sizes of different packets; obtaining the continuation packet number according to the start packet number and the second upload size, the continuation packet number corresponds to one of the multiple packets; and subtracting the second upload size from the first authorization remaining size to obtain the second authorization remaining size. The packet upload procedure includes: storing data of the packet corresponding to the continuation packet number and continuation packets thereof to the upload queue one by one, and summing the data sizes of the packet corresponding to the continuation packet number and the continuation packets thereof to calculate a second summation result, and determining whether the second summation result meets a second stop condition or not after working out the second summation result one by one, the second stop condition is that the second authorization remaining size minus the second summation result is less than the data size.

In one embodiment, a network device coupled to an optical line terminal and a user terminal device includes a first output/input port, a controller, a buffer and a second output/input port. The first output/input port is coupled to the optical line terminal. The controller includes a page queue. The page queue includes multiple sequential page records, and each page record includes a page size and an auxiliary queue, wherein the auxiliary queue includes multiple sequential packets corresponding to the page record, and the page size is a sum of data sizes of the packets corresponding to the page record. The controller is configured to execute a data uploading method, and the data uploading method includes: receiving an authorization message from the optical line terminal through the first output/input port, the authorization message includes an authorization size; executing an upload procedure to obtain an upload queue, the upload procedure includes: executing the page queue upload procedure according to the page queue and the authorization size to obtain a first authorization remaining size and a continuation page number; executing a remaining queue upload procedure according to the first authorization remaining size, the continuation page number and a remainder parameter to obtain a continuation packet number and a second authorization remaining size; and executing a packet upload procedure according to the continuation packet number and the second authorization remaining size; and uploading the packet data stored in the upload queue to the optical line terminal through the first output/input port. The buffer is coupled to the controller. The buffer is configured to store the data of the packets corresponding to the multiple page records. The second output/input port is coupled to the user terminal device. The second output/input port is configured to receive the data of the packets corresponding to the multiple page records from the user terminal device.

In one embodiment, a network device coupled to an optical line terminal and a user terminal device includes a first output/input port, a controller, a buffer and a second output/input port. The first output/input port is coupled to the optical line terminal. The controller includes a page queue. The page queue includes multiple sequential page records, and each page record includes a page size and an auxiliary queue, wherein the auxiliary queue includes multiple sequential packets corresponding to the page record, and the page size is a sum of data sizes of the packets corresponding to the page record. The controller is configured to execute a data uploading method, and the data uploading method includes: receiving an authorization message from the optical line terminal through the first output/input port, the authorization message includes an authorization size; executing an upload procedure to obtain an upload queue, the upload procedure includes: executing the page queue upload procedure according to the page queue and the authorization size to obtain a first authorization remaining size and a continuation page number; executing a remaining queue upload procedure according to the first authorization remaining size, the continuation page number and a remainder parameter to obtain a continuation packet number and a second authorization remaining size; and executing a packet upload procedure according to the continuation packet number and the second authorization remaining size; and uploading the packet data stored in the upload queue to the optical line terminal through the first output/input port. The buffer is coupled to the controller. The buffer is configured to store the data of the packets corresponding to the multiple page records. The second output/input port is coupled to the user terminal device. The second output/input port is configured to receive the data of the packets corresponding to the multiple page records from the user terminal device. The page queue upload procedure includes: obtaining a start page number according to the page queue, the start page number corresponds to one of the multiple page records; storing data of the packets corresponding to the page record corresponding to the start page number and continuation page records thereof to the upload queue page by page, and summing the page sizes of the page record corresponding to the start page number and the continuation page records thereof to calculate a first summation result, and determining whether the first summation result meets a first stop condition or not after working out the first summation result page by page, the first stop condition is that the authorization size minus the first summation result is less than the page size; when the first stop condition is met, taking the first summation result as a first upload size, and subtracting the first upload size from the authorization size to obtain a first authorization remaining size; and obtaining the continuation page number according to a page record that follows the last page record in the first summation result. The remaining queue upload procedure includes: subtracting a remainder derived from the first authorization remaining size divided by the remainder parameter from the first authorization remaining size to obtain a second upload size; storing data of part of packets corresponding to the page record corresponding to the continuation page number to the upload queue according to the continuation page number and the second upload size, a sum of data sizes of the part of packets corresponding to the page record corresponding to the continuation page number stored to the upload queue is equal to the second upload size; obtaining a start packet number according to an auxiliary queue of the page record corresponding to the continuation page number, the start packet number corresponds to one of multiple packets, and each packet includes data sizes of different packets; obtaining the continuation packet number according to the start packet number and the second upload size, the continuation packet number corresponds to one of the multiple packets; and subtracting the second upload size from the first authorization remaining size to obtain the second authorization remaining size. The packet upload procedure includes: storing data of the packet corresponding to the continuation packet number and continuation packets thereof to the upload queue one by one, and summing the data sizes of the packet corresponding to the continuation packet number and the continuation packets thereof to calculate a second summation result, and determining whether the second summation result meets a second stop condition or not after working out the second summation result one by one, the second stop condition is that the second authorization remaining size minus the second summation result is less than the data size.

### BRIEF DESCRIPTION OF THE DRAWINGS

FIG. 1 is a schematic application diagram of one embodiment of a network device.

FIG. 2 is a flow chart of one embodiment of a data uploading method.

FIG. 3 is a schematic diagram of one embodiment of a page queue.

FIG. 4 is a schematic diagram of one embodiment of an auxiliary queue.

FIG. 5 is a flow chart of one embodiment of an upload procedure.

FIG. 6 is a flow chart of one embodiment of a page queue upload procedure.

FIG. 7 is a flow chart of one embodiment of a remaining queue upload procedure.

FIG. 8 is a schematic diagram of one embodiment of a packet upload procedure.

### DETAILED DESCRIPTION

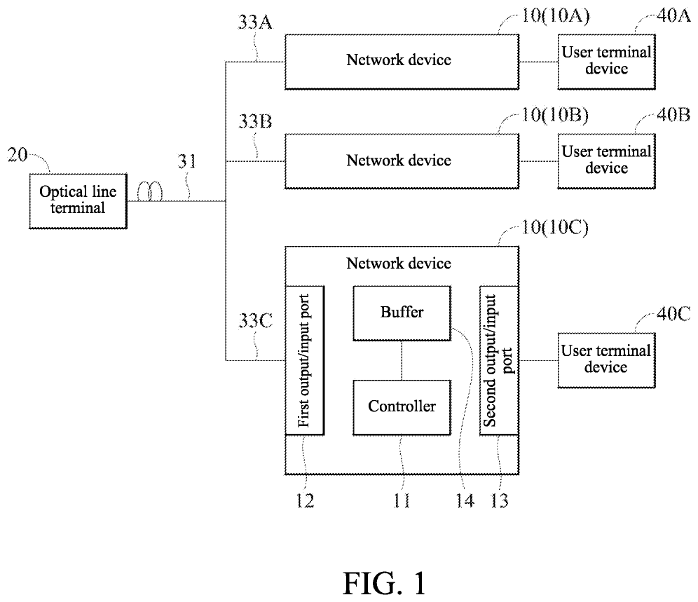

The present invention is applied to a point-to-multipoint communication transmission architecture. For the convenience of illustration, the characteristics of the present invention is illustrated with a passive optical network as an example, which is not a limitation of the present invention. The passive optical network is an optics communication network consisting of an optical line terminal, optical network units and an optical distribution network. FIG. 1 is a schematic application diagram of one embodiment of a network device 10. Referring to FIG. 1. In the embodiment of FIG. 1, it is illustrated with three network devices 10, but the number of the network devices 10 is not limited thereto. For the convenience of illustration, the three network devices 10 are called a network device 10A, a network device 10B and a network device 10C respectively. The optical line terminal 20 is coupled to a main optical fiber 31. The network devices 10A-10C are respectively coupled to corresponding sub-optical fibers 33A-33C and corresponding user terminal devices 40A-40C. The main optical fiber 31 and the sub-optical fibers 33A-33C may be the aforementioned optical distribution network. The network device 10A-10C can be the aforementioned optical network units. In some embodiments, the main optical fiber 31 and the multiple sub-optical fibers 33A-33C may be but not limited to a one-to-multiple optical coupler, an optical splitter, or an optical combiner. The optical line terminal 20 is coupled to the network devices 10A-10C via the main optical fiber 31 and the sub-optical fibers 33A-33C to achieve the point (optical line terminal 20) to multipoint (network devices 10A-10C) communication transmission. The optical line terminal 20 is configured to allocate an authorization message M and a time slot for uplink transmission to the network devices 10A-10C during downlink transmission. In some embodiments, the user terminal devices 40A-40C may be but not limited to a desktop computer, a notebook computer, a server, and the like.

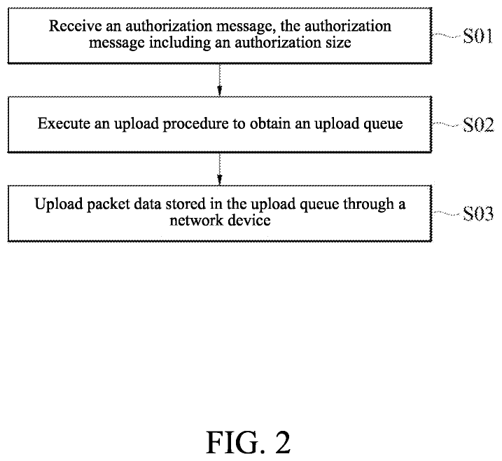

For the convenience of illustration, only a detailed circuit block diagram of the network device 10C is illustrated in FIG. 1. FIG. 2 is a flow chart of one embodiment of a data uploading method. Referring to FIG. 1 and FIG. 2. The network devices 10A-10C include a controller 11.

The controller 11 includes a page queue 50 and is configured to receive the authorization message M (step S01). The authorization message M includes an authorization size S. The authorization size S is a data size that the optical line terminal 20 allows the network devices 10A-10C to transmit in the time slot for the uplink transmission. After receiving the authorization message M, the controller 11 executes an upload procedure P0 to obtain an upload queue UQ (step S02). The controller 11 uploads packet data stored in the upload queue UQ after obtaining the upload queue UQ (step S03).

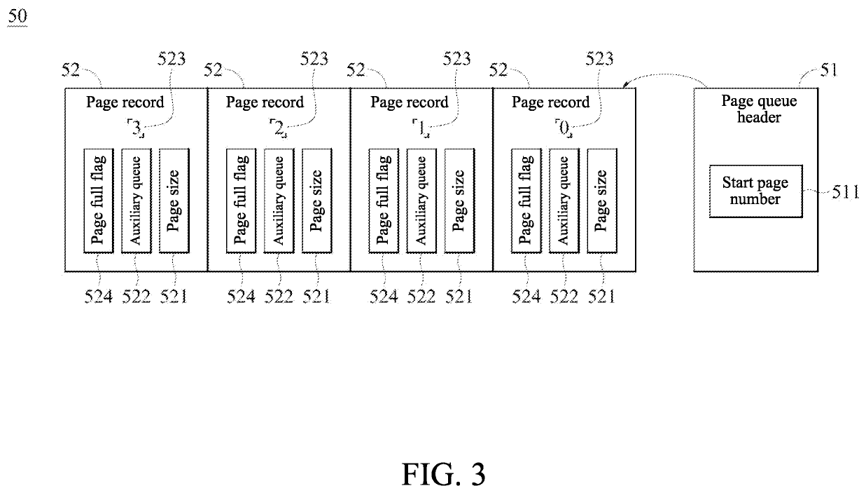

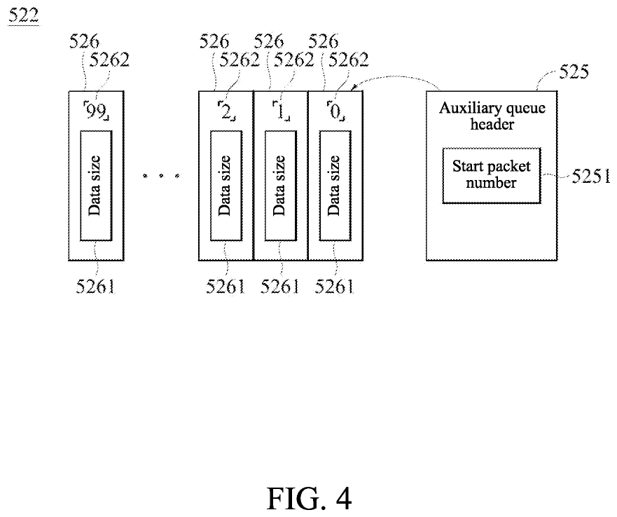

FIG. 3 is a schematic diagram of one embodiment of the page queue 50. Referring to FIG. 3. The page queue 50 includes a page queue header 51 and multiple sequential page records 52. The page queue header 51 includes a start page number 511. Each page record 52 includes a page size 521, an auxiliary queue 522, and a page number 523. FIG. 4 is a schematic diagram of one embodiment of the auxiliary queue 522. Referring to FIG. 3 and FIG. 4. The auxiliary queue 522 includes an auxiliary queue header 525 and multiple sequential packets 526 corresponding to the page records 52. The auxiliary queue header 525 includes a start packet number 5251. Each packet 526 includes a data size 5261 and a packet number 5262 of the packet 526. Each page record 52 can be distinguished by the page number 523. For example, the page record 52 with the page number 523 of “0” is a first page record, the page record 52 with the page number 523 of “1” is a second page record, and so on. Each packet 526 can be distinguished by the packet number 5262. For example, the packet 526 with the packet number 5262 of “0” is a first packet, the packet 526 with the packet number 5262 of “1” is a second packet, and so on. In some embodiments, the multiple packets 526 and the multiple page records 52 can be arranged in sequence of the packets received by the controller 11 from the corresponding user terminal devices 40A-40C.

The page size 521 is a sum of the data sizes 5261 of the multiple packets 526 corresponding to the page records 52. By way of examples, if the first page record (the page record 52 with the page number 523 being “0”) corresponds to the first packet to a 100^{th} packet, the page size 521 of the first page record is a sum of the data size 5261 of the first packet to the data size 5261 of the 100^{th} packet. If the second page record (the page record 52 with the page number 523 of “1”) corresponds to a 101^{th} packet to a 200^{th} packet, the page size 521 of the second page record is a sum of the data size 5261 of the 101^{th} packet to the data size 5261 of the 200^{th} packet. In some embodiments, the number of the multiple packets 526 corresponding to the page records 52 can be set according to user's needs. In some embodiments, the data size 5261 of each packet 526 is the same, and the number of the multiple packets 526 corresponding to all the page records 52 is the same. In other words, in some embodiments, the page size 521 of each page record 52 is the same.

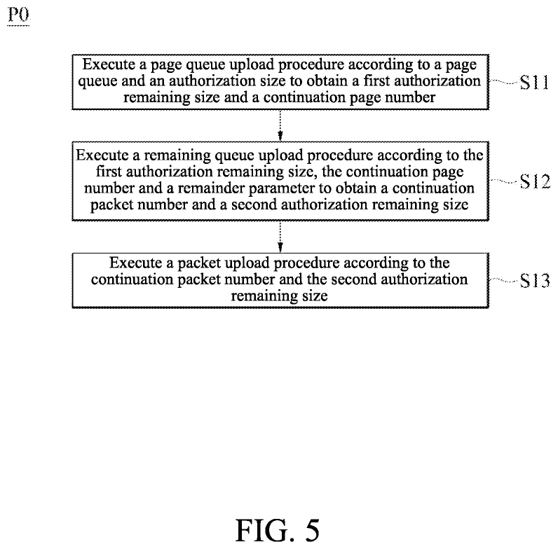

FIG. 5 is a flow chart of one embodiment of an upload procedure P0. Referring to FIG. 1 to FIG. 5. After the controller 11 receives the authorization message M, the controller 11 executes a page queue upload procedure P1 according to the page queue 50 and the authorization size S to obtain a first authorization remaining size R1 and a continuation page number N1 (step S11). Subsequently, the controller 11 executes a remaining queue upload procedure P2 according to the first authorization remaining size R1, the continuation page number N1 and a remainder parameter R to obtain a continuation packet number N2 and a second authorization remaining size R2 (step S12). After the controller 11 executes the remaining queue upload procedure P2, the controller 11 executes a packet upload procedure P3 according to the continuation packet number N2 and the second authorization remaining size R2 (step S13).

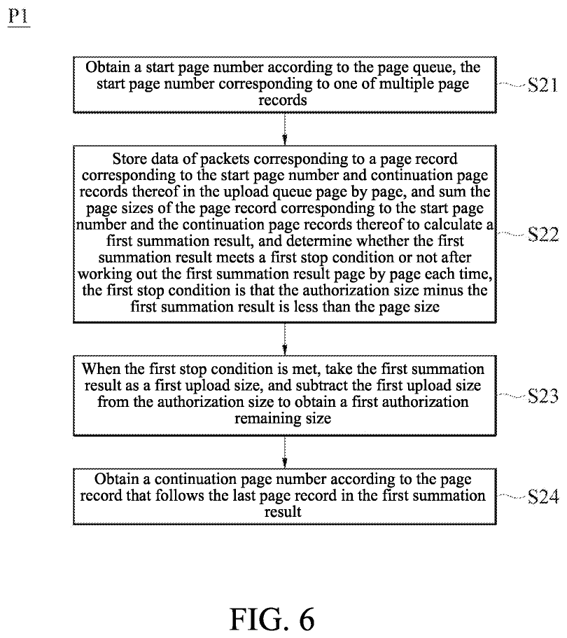

FIG. 6 is a flow chart of one embodiment of the page queue upload procedure P1. Referring to FIG. 1 to FIG. 6. Firstly, the controller 11 obtains the start page number 511 according to the page queue 50, and the start page number 511 corresponds to one of the multiple page records 52 (step S21). Specifically, the start page number 511 corresponds to the first page record 52 to be uploaded. By way of examples, assuming that the start page number 511 is “0”, the first page record to be uploaded is the page record 52 with the page number 523 of “0”.

Subsequently, the controller 11 stores the data of the packets corresponding to the page record 52 corresponding to the start page number 511 and continuation page records 52 thereof page by page to the upload queue UQ, and sums the page sizes 521 of the page record 52 corresponding to the start page number 511 and the continuation page records 52 thereof to calculate a first summation result Sum1, and determines whether the first summation result Sum1 meets a first stop condition S1 or not after working out the first summation result Sum1 page by page each time (step S22). The first stop condition S1 is that the authorization size S minus the first summation result Sum1 is less than the page size 521.

When the first stop condition S1 is met, the controller 11 takes the first summation result Sum1 as a first upload size U1, and subtracts the first upload size U1 from the authorization size S to obtain the first authorization remaining size R1 (step S23). Subsequently, the controller 11 obtains the continuation page number N1 according to the page record 52 that follows the last page record 52 in the first summation result Sum1 (step S24).

By way of examples, if the data size 5261 of each packet 526 is 80 B (Bytes) and the number of the multiple packets 526 corresponding to each page record 52 is 100, that is, the page size 521 of each page record 52 is 8000 B, if the authorization size S provided by the optical line terminal 20 at this time is 78070 B and the start page number 511 is “0”, the controller 11 then stores the data of 100 packets 526 corresponding to the page record 52 with the page number 523 of “0” and the continuation page records 52 thereof page by page to the upload queue UQ, and sums the page sizes 521 of 8000 B of the page record 52 with the page number 523 of “0” and the continuation page records 52 thereof to calculate the first summation result Sum1 (the first summation result Sum1 for the first time is 8000 B, the first summation result Sum1 for the second time is 16000 B, the first summation result Sum1 for the third time is 24000 B, and so on). After working out the first summation result Sum1 page by page each time, the controller 11 determines whether the first summation result Sum1 meets that 78070 B (the authorization size S) minus the first summation result Sum1 is less than 8000 B (the page size 521) or not. When the first summation result Sum1 is 72000 B (the first summation result Sum1 for the ninth time), 78070 B (the authorization size S) minus the first summation result Sum1 is 6070 B, and 6070 B is less than 8000 B (the page size 521). At this time, the controller 11 takes 72000 B (the first summation result Sum1) as the first upload size U1, and subtracts 72000 B (the first upload size U1) from 78070 B (the authorization size S) to obtain the first authorization remaining size R1. At this time, the first authorization remaining size R1 is 6070 B. Subsequently, the controller 11 obtains the continuation page number N1 according to the page record 52 that follows the last page record 52 in the first summation result Sum1. At this time, since 72000 B is the first summation result Sum1 for the ninth time, the last page record 52 in the first summation result Sum1 is the page record 52 with the page number 523 of “8”, and the page record 52 that follows the last page record 52 in the first summation result Sum1 is the page record 52 with the page number 523 of “9”. In other words, the continuation page number N1 is “9”.

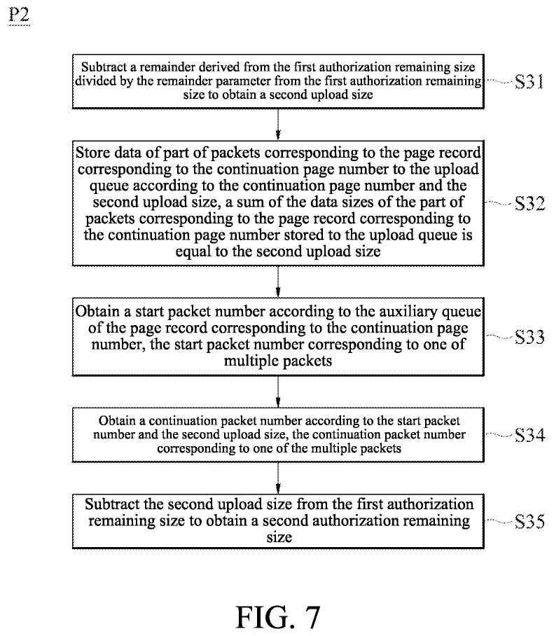

FIG. 7 is a flow chart of one embodiment of the remaining queue upload procedure P2. Referring to FIG. 1 to FIG. 7. Firstly, the controller 11 subtracts a remainder derived from the first authorization remaining size R1 divided by the remainder parameter R from the first authorization remaining size R1 to obtain a second upload size U2 (step S31). In some embodiments, the value of the remainder parameter R can be set according to user's needs. In some embodiments, the value of the remainder parameter R is a multiple of the data size 5261 of each packet 526.

Then, the controller 11 stores the data of part of the packets 526 corresponding to the page record 52 corresponding to the continuation page number N1 to the upload queue UQ according to the continuation page number N1 and the second upload size U2, and a sum of the data sizes of the part of packets 526 corresponding to the page record 52 corresponding to the continuation page number N1 stored to the upload queue UQ is equal to the second upload size U2 (step S32). Subsequently, the controller 11 obtains the start packet number 5251 according to the auxiliary queue 522 of the page record 52 corresponding to the continuation page number N1, and the start packet number 5251 corresponds to one of the multiple packets 526 (step S33). Specifically, the start packet number 5251 corresponds to the first packet 526 to be uploaded in the auxiliary queue 522. By way of examples, assuming that the start packet number 5251 is “0”, the first packet 526 to be uploaded in the auxiliary queue 522 is the packet 526 with the packet number 5262 of “0”.

Subsequently, the controller 11 obtains the continuation packet number N2 according to the start packet number 5251 and the second upload size U2, and the continuation packet number N2 corresponds to one of the multiple packets 526 (step S34). Finally, the controller 11 subtracts the second upload size U2 from the first authorization remaining size R1 to obtain the second authorization remaining size R2 (step S35).

By way of examples, in terms of the above example, assuming that the continuation page number N1 is “9” and the first authorization remaining size R1 is 6070 B, if a user sets the remainder parameter R as 720 B at this time, the controller 11 will first subtract 310 B (the remainder derived from the first authorization remaining size R1 divided by the remainder parameter R) from 6070 B (the first authorization remaining size R1) to obtain the second upload size U2, and the second upload size U2 at this time is 5760 B. Then, the controller 11 stores the data of part of the packets 526 corresponding to the page record 52 with the page number 523 of “9” to the upload queue UQ according to the continuation page number N1 and the second upload size U2, and a sum of the data sizes of the part of packets 526 corresponding to the page record 52 corresponding to the continuation page number N1 stored to the upload queue UQ is equal to 5760 B (the second upload size U2). Subsequently, the controller 11 obtains the start packet number 5251 according to the auxiliary queue 522 of the page record 52 with the page number 523 of “9”, and the start packet number 5251 at this time is “0”. Then, the controller 11 obtains the continuation packet number N2 according to the start packet number 5251 and the second upload size U2. Since 5760 B (the second upload size U2) is 72 times of 80 B (the data size 5261 of each packet 526), the continuation packet number N2 should correspond to a 73^{th} packet 526. In other words, the continuation packet number N2 at this time is “72”. Finally, the controller 11 subtracts 5760 B (the second upload size U2) from 6070 B (the first authorization remaining size R1) to obtain the second authorization remaining size R2, and the second authorization remaining size R2 at this time is 310 B.

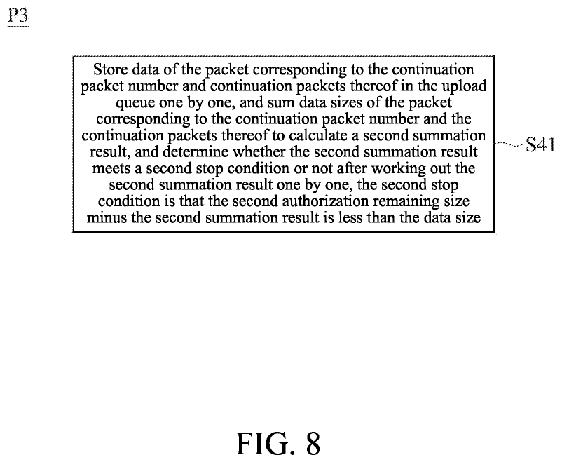

FIG. 8 is a schematic diagram of one embodiment of the packet upload procedure P3. Referring to FIG. 1 to FIG. 8. After the controller 11 executes the remaining queue upload procedure P2, the controller 11 stores the data of the packet 526 corresponding to the continuation packet number N2 and the continuation packets 526 thereof one by one to the upload queue UQ and sums the data sizes 5261 of the packet 526 corresponding to the continuation packet number N2 and the continuation packets 526 thereof to calculate a second summation result Sum2, and determines whether the second summation result Sum2 meets a second stop condition S2 or not after working out the second summation result Sum2 one by one, and the second stop condition S2 is that the second authorization remaining size S2 minus the second summation result Sum2 is less than the data size 5261 (step S41).

By way of examples, in terms of the above example, assuming that the data size 5261 of each packet 526 is 80 B, the continuation page number N1 is “9”, the continuation packet number N2 is “72”, and the second authorization remaining size S2 is 310 B, the controller 11 then stores the data of the packet 526 with the packet number 5262 of “72” and the continuation packets 526 thereof in the auxiliary queue 522 of the page record 52 with the page number 523 of “9” one by one to the upload queue UQ and sums the data sizes 5261 of the packet 526 with the packet number 5262 of “72” and the continuation packets 526 thereof in the auxiliary queue 522 of the page record 52 with the page number 523 of “9” to calculate the second summation result Sum2 (the second summation result Sum2 for the first time is 80 B, the second summation result Sum2 for the second time is 160 B, the second summation result Sum2 for the third time is 240 B, and so on). After working out the second summation result Sum2 one by one each time, the controller 11 determines whether the second summation result Sum2 meets that 310 B (the second authorization remaining size S2) minus the second summation result Sum2 is less than 80 B (the data size 5261) or not. When the second summation result Sum2 is 240 B (the second summation result Sum2 for the third time), 310 B (the second authorization remaining size S2) minus the second summation result Sum2 is 70 B, and 70 B is less than 80 B (the data size 5261). At this time, the packet data stored in the upload queue UQ is all the packet data that can be uploaded by the controller 11 in the time slot for uplink transmission allocated by the optical line terminal 20.

In the time slot for uplink transmission allocated by the optical line terminal 20, the controller 11 uploads the packet data stored in the upload queue UQ to the optical line terminal 20.

In a process of executing the page queue upload procedure P1, the controller 11 firstly works out the first upload size U1 in unit of the page size 521 (that is, in unit of the packet group), and the first upload size U1 is the sum of the data sizes 5261 of the multiple packets 526. Subsequently, in a process of executing the remaining queue upload procedure P2, the controller 11 works out the second upload size U2 according to the first authorization remaining size R1 and the remainder parameter R, and the second upload size U2 is also the sum of the data sizes 5261 of the multiple packets 526. Until the controller 11 executes the packet upload procedure P3, the controller 11 calculates the data sizes 5261 of the packets 526 packet by packet. Compared with a previous technology to work out the data that conforms to the allowable upload data size packet by packet, the network device 10 proposed by the present invention works out the first upload size U1 and the second upload size U2 based on the sum of the data sizes 5261 of the multiple packets 526 instead of packet-by-packet calculation in a process of executing the page queue upload procedure P1 and the remaining queue upload procedure P2. Until the packet upload procedure P3 is executed, the network device 10 calculates the data sizes 5261 of the packets 526 packet by packet. Since the number of packet-by-packet calculations is greatly reduced, compared with the previous technology, the network device 10 proposed in the present invention can work out the data that conforms to the allowable upload data size more quickly.

By way of examples, in terms of the above example, assuming that the data size 5261 of each packet 526 is 80 B and the authorization size S provided by the optical line terminal 20 is 78070 B, if the time required for a single calculation is 12 nanoseconds (ns) at this time, for the previous technology, since up to 975 packets can be uploaded at 78070 B, the time that is taken to work out the data that conforms to the allowable upload size is 11.7 microseconds (μs) (12 ns*975=11.7 μs). For the network device 10 proposed in the present invention, assuming that the number of the multiple packets 526 corresponding to each of the page records 52 is 100, that is, when the page size 521 of each record page 52 is 8000 B and the remainder parameter R is set as 720 B, the time that is taken to work out the first upload size U1 is 108 ns (12 ns*9=108 ns), the time that is taken to work out the second upload size U2 is 12 ns (12 ns*1=12 ns), and the time taken for the packet-by-packet calculation when executing the packet upload procedure P3 is 36 ns (12 ns*3=36 ns), and therefore, the time required for working out the data that conforms to the allowable upload size is 156 ns (108 ns+12 ns+36 ns=156 ns). In terms of the above example, the network device 10 proposed in the present invention is 75 times faster than the previous technology to work out the data that conforms to the allowable upload data size.

Since when the authorization size S is greater than all the packet data stored in the network device 10, it means that in the time slot for uplink transmission allocated by the optical line terminal 20, the network device 10 can upload all the packet data stored therein to the optical line terminal 20, with no need of calculating the data that conforms to the allowable upload data size by executing the upload procedure P0. Therefore, in some embodiments, the controller 11 is further configured to determine whether the authorization size S is greater than or equal to the sum of the page sizes 521 of all the multiple page records 52 in the page queue 50 or not after receiving the authorization message M. When the authorization size S is greater than or equal to the sum of the page sizes 521 of all the multiple page records 52 in the page queue 50, the controller 11 uploads the data of the packets 526 corresponding to all the multiple page records 52 in the page queue 50, instead of executing the upload procedure P0. When the authorization size S is less than the sum of the page sizes 521 of all the multiple page records 52 in the page queue 50, the controller 11 executes the upload procedure P0.

Byway of examples, assuming that the authorization size S provided by the optical line terminal 20 is 78070 B, the data size 5261 of each packet 526 is 80 B, and the number of the multiple packets 526 corresponding to each of the page records 52 is 100, that is, the page size 521 of each page record 52 is 8000 B, if there are only 8 page records 52 in the page queue 50 at this time, because 78070 B (the authorization size S) is greater than 64000 B (the sum of the page sizes 521 of all the multiple page records 52 in the page queue 50), the controller 11 uploads the data of the packets 526 corresponding to the 8 page records 52 in the page queue 50, instead of executing the upload procedure P0.

Since when the first authorization remaining size R1 is equal to zero or less than the data size 5261, it represents that the authorization size S at this time can no longer load more upload size. Therefore, in some embodiments, when the first authorization remaining size R1 is equal to zero or less than the data size 5261, the controller 11 uploads the packet data stored in the upload queue UQ.

Since when the second authorization remaining size R2 is equal to zero or less than the data size 5261, it represents that the authorization size S at this time can no longer load more upload size. Therefore, in some embodiments, when the second authorization remaining size R2 is equal to zero or less than the data size 5261, the controller 11 uploads the packet data stored in the upload queue UQ.

In some embodiments, when the first authorization remaining size R1 is less than the remainder parameter R, the controller 11 will set the second upload size as zero. When the controller 11 sets the second upload size as zero, it represents that the controller 11 will not store any data to the upload queue UQ when executing the remaining queue upload procedure P2. In other words, the remaining packets 526 stored to the upload queue UQ will be stored to the upload queue UQ packet by packet until the controller 11 executes the packet upload procedure P3.

In some embodiments, when the first stop condition S1 is met, the controller 11 further updates the start page number 511 according to the page record 52 that follows the last page record 52 in the first summation result Sum1.

By way of examples, in terms of the above example, assuming that when the first stop condition S1 is met, the first summation result Sum1 is the first summation result Sum1 for the ninth time, and the last page record 52 in the first summation result Sum1 is the page record 52 with the page number 523 of “8”, and the page record 52 that follows the last page record 52 in the first summation result Sum1 is the page record 52 with the page number 523 of “9”. At this time, the controller 11 updates the start page number 511 to “9”.

Referring to FIG. 3. In some embodiments, each page record 52 further includes a page full flag 524. When the first stop condition S1 is met and the first authorization remaining size R1 is greater than the data size 5261, the controller 11 further sets the page full flag 524 of the page record 52 that follows the last page record 52 in the first summation result Sum1 as a non-full value.

By way of examples, in terms of the above example, assuming that when the first stop condition S1 is met, the first summation result Sum1 is the first summation result Sum1 for the ninth time, and the last page record 52 in the first summation result Sum1 is the page record 52 with the page number 523 of “8”, and the page record 52 that follows the last page record 52 in the first summation result Sum1 is the page record 52 with the page number 523 of “9”. At this time, if the first authorization remaining size R1 is greater than the data size 5261, the controller 11 will set the page full flag 524 of the page record 52 with the number 523 of “9” as a non-full value.

In some embodiments, when the second stop condition S2 is met, the controller 11 further updates the start packet number 5251 according to the packet 526 that follows the last packet 526 in the second summation result Sum2.

By way of examples, in terms of the above example, assuming that when the second stop condition S2 is met, the second summation result Sum2 is the second summation result Sum2 for the third time, the last packet 526 in the second summation result Sum2 is the packet 526 with the packet number 5262 of “2”, and the packet 526 that follows the last packet 526 in the second summation result Sum2 is the packet 526 with the packet number 5262 of “3”. At this time, the controller 11 will update the start packet number 5251 to “3”.

In some embodiments, when the page full flag 524 of the page record 52 corresponding to the start page number 511 is a non-full value, the controller 11 further stores the data of the packet 526 corresponding to the start packet number 5251 of the page record 52 corresponding to the start page number 511 and the continuation packets 526 thereof one by one to the upload queue UQ and sum the data sizes 5261 of the packet 526 corresponding to the start packet number 5251 of the page record 52 corresponding to the start page number 511 and the continuation packets 526 thereof to calculate a third summation result Sum3, and update the start page number 511 according to the page record 52 that follows the page record 52 corresponding to the start page number 511. Subsequently, the controller 11 further stores the data of the packets 526 corresponding to the page record 52 corresponding to the start page number 511 and the continuation page records 52 thereof page by page to the upload queue UQ, and sums the page sizes 521 of the page record 52 corresponding to the start page number 511 and the continuation page records 52 thereof to calculate the first summation result Sum1, and determines whether the first summation result Sum1 meets the third stop condition S3 or not after working out the first summation result Sum1 page by page each time. The third stop condition S3 is that the authorization size S minus the first summation result Sum1 and the third summation result Sum3 is less than the page size 521. When the third stop condition S3 is met, the controller 11 further takes the first summation result Sum1 plus the third summation result Sum3 as the first upload size U1 and subtracts the first upload size U1 from the authorization size S to obtain the first authorization remaining size R1.

By way of examples, in terms of the above example, assuming that when the page record 52 corresponding to the start page number 511 is the page record 52 with the page number 523 of “9”, and the page full flag 524 thereof is also a non-full value, and the start packet number 5251 thereof is “3”, the controller 11 then stores the data of the packet 526 with the packet number 5262 of “3” and the continuation packets 526 thereof in the page record 52 with the page number 523 of “9” one by one to the upload queue UQ and sums the data sizes 5261 of the packet 526 with the packet number 5262 of “3” and the continuation packets 526 thereof to calculate the third summation result Sum3, and updates the start page number 511 according to the page record 52 that follows the page record 52 with the page number 523 of “9”. At this time, the start page number 511 is “10”. Subsequently, the controller 11 further stores the data of the packet 526 corresponding to the page record 52 with the page number 523 of “10” and the continuation page records 52 thereof page by page to the upload queue UQ and sums the page sizes 521 of the page record 52 with the page number 523 of “10” and the continuation page records 52 thereof to calculate the first summation result Sum1, and determines whether the first summation result Sum1 meets the third stop condition S3 or not after working out the first summation result Sum1 page by page each time. The third stop condition S3 is that the authorization size S minus the first summation result Sum1 and the third summation result Sum3 is less than the page size 521. When the third stop condition S3 is met, the controller 11 further takes the first summation result Sum1 plus the third summation result Sum3 as the first upload size U1 and subtracts the first upload size U1 from the authorization size S to obtain the first authorization remaining size R1.

In some embodiments, when the third stop condition S3 is met, the controller 11 further updates the start page number 511 according to the page record 52 that follows the last page record 52 in the first summation result Sum1.

In some embodiments, in the network device according to claim 28, when the third stop condition S3 is met and the first authorization remaining size R1 is greater than the data size 5261, the controller 11 further sets the page full flag 524 of the page record 52 that follows the last page record 52 in the first summation result Sum1 as a non-full value.

In some embodiments, the controller 11 subtracts a remainder derived from the first authorization remaining size R1 divided by the data size 5261 from the first authorization remaining size R1 to obtain the second upload size U2. Subsequently, the controller 11 stores the data of part of the packets 526 corresponding to the page record 52 corresponding to the continuation page number N1 to the upload queue UQ according to the continuation page number N1 and the second upload size U2. The sum of the data sizes of the part of packets 526 corresponding to the page record 52 corresponding to the continuation page number N1 stored to the upload queue UQ is equal to the second upload size U2. After that, the controller 11 sets the second authorization remaining size R2 as zero. Moreover, since when the second authorization remaining size R2 is equal to zero or less than the data size 5261, it represents that the authorization size S at this time can no longer load more upload size. Therefore, the controller 11 further uploads the packet data stored in the upload queue UQ after setting the second authorization remaining size R2 as zero.

By way of examples, in terms of the above example, assuming that the continuation page number N1 is “9”, the first authorization remaining size R1 is 6070 B, and the data size 5261 is 80 B, the controller 11 firstly subtracts 70 B (the remainder derived from the first authorization remaining size R1 divided by the data size 5261) from 6070 B (the first authorization remaining size R1) to obtain the second upload size U2, and the second upload size U2 at this time is 6000 B. Then, the controller 11 stores the data of part of the packets 526 corresponding to the page record 52 with the page number 523 of “9” to the upload queue UQ according to the continuation page number N1 and the second upload size U2, and a sum of the data sizes of the part of packets 526 corresponding to the page record 52 corresponding to the continuation page number N1 stored to the upload queue UQ is equal to 6000 B (the second upload size U2). Subsequently, the controller 11 uploads the packet data stored in the upload queue UQ. At this time, the time that the network device 10 takes to work out the data that conforms to the allowable upload data size is only 120 ns (108 ns+12 ns=120 ns).

In some embodiments, the controller 11 may be operational circuits, such as a central processing unit, a microprocessor, an application-specific integrated circuit, an embedded system, or a system-on-chip. The type of the controller 11 is not limited here.

In some embodiments, the network devices 10A-10C further include a first output/input port 12 and a second output/input port 13. The first output/input port 12 is coupled to the optical line terminal 20 via the corresponding sub-optical fiber 33A-33C and the main optical fiber 31. The second output/input port 13 is coupled to the corresponding user terminal devices 40A-40C. The first output/input port 12 is configured to perform transmission with the optical line terminal 20. For example, during the downlink transmission, the first output/input port 12 receives the authorization message and the allocated time slot from the optical line terminal 20, and in the time slot for the uplink transmission, the first output/input port 12 outputs data (i.e., packets) that conforms to or less than the authorization size to the optical line terminal 20. The second output/input port 13 is configured to perform transmission with the corresponding user terminal devices 40A-40C. For example, the second output/input port 13 receives packets from the corresponding user terminal devices 40A-40C.

In some embodiments, the network devices 10A-10C further include a buffer 14. The buffer 14 is configured to store the data of the packets 526 corresponding to multiple page records 52. The buffer 14 may be a volatile storage medium, a non-volatile storage medium or a combination thereof. The volatile storage medium may be, for example, a random access memory. The non-volatile storage medium may be, for example, a read-only memory. The type of the buffer 14 is not limited here.

To sum up, in some embodiments, the network device 10 works out the first upload size U1 and the second upload size U2 based on the sum of the data sizes 5261 of the multiple packets 526 instead of packet-by-packet calculation in the process of executing the page queue upload procedure P1 and the remaining queue upload procedure P2. Until the packet upload procedure P3 is executed, the network device 10 calculates the data sizes 5261 of the packets 526 packet by packet. Since the number of packet-by-packet calculations is greatly reduced, compared with the previous technology, the network device 10 proposed in the present invention can work out the data that conforms to the allowable upload data size more quickly.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A data uploading method, applying to a network device, the network device comprising a page queue, the data uploading method comprising:
receiving an authorization message, the authorization message comprising an authorization size;
executing an upload procedure to obtain an upload queue, the upload procedure comprising:
executing a page queue upload procedure according to the page queue and the authorization size to obtain a first authorization remaining size and a continuation page number;
executing a remaining queue upload procedure according to the first authorization remaining size, the continuation page number and a remainder parameter to obtain a continuation packet number and a second authorization remaining size; and
executing a packet upload procedure according to the continuation packet number and the second authorization remaining size; and
uploading packet data stored in the upload queue through the network device.

2. The data uploading method according to claim 1, wherein the page queue upload procedure comprises:
obtaining a start page number according to the page queue, wherein the page queue comprises multiple sequential page records, the start page number corresponds to one of the page records, and each page record comprises a page size and an auxiliary queue, wherein the auxiliary queue comprises multiple sequential packets corresponding to the page record, and the page size is a sum of data sizes of the packets corresponding to the page record;
storing data of the packets corresponding to the page record corresponding to the start page number and the continuation page records thereof to the upload queue page by page, and summing the page sizes of the page record corresponding to the start page number and the continuation page records thereof to calculate a first summation result, and determining whether the first summation result meets a first stop condition or not after working out the first summation result page by page each time, wherein the first stop condition is that the authorization size minus the first summation result is less than the page size;
when the first stop condition is met, taking the first summation result as a first upload size, and subtracting the first upload size from the authorization size to obtain a first authorization remaining size; and
obtaining the continuation page number according to the page record that follows the last page record in the first summation result.

3. The data uploading method according to claim 2, wherein the remaining queue upload procedure comprises:
subtracting a remainder derived from the first authorization remaining size divided by the remainder parameter from the first authorization remaining size to obtain a second upload size;
storing data of part of packets corresponding to the page record corresponding to the continuation page number to the upload queue according to the continuation page number and the second upload size, wherein a sum of data sizes of the part of packets corresponding to the page record corresponding to the continuation page number stored to the upload queue is equal to the second upload size;
obtaining a start packet number according to the auxiliary queue of the page record corresponding to the continuation page number, the start packet number corresponding to one of the packets, and each packet comprising the data size of the packet;
obtaining the continuation packet number according to the start packet number and the second upload size, the continuation packet number corresponding to one of the packets; and
subtracting the second upload size from the first authorization remaining size to obtain the second authorization remaining size.

4. The data uploading method according to claim 3, wherein the packet upload procedure comprises:
storing data of the packet corresponding to the continuation packet number and the continuation packets thereof to the upload queue one by one, and summing the data sizes of the packet corresponding to the continuation packet number and the continuation packets thereof to calculate a second summation result, and determining whether the second summation result meets a second stop condition or not after working out the second summation result one by one, wherein the second stop condition is that the second authorization remaining size minus the second summation result is less than the data size.

5. The data uploading method according to claim 4, further comprising:
after receiving the authorization message, determining whether the authorization size is greater than or equal to a sum of the page sizes of all the page records in the page queue or not; and
when the authorization size is greater than or equal to the sum of the page sizes of all the page records in the page queue, uploading the data of the packets corresponding to all the page records in the page queue through the network device.

6. The data uploading method according to claim 5, further comprising:
when the authorization size is less than the sum of the page sizes of all the page records in the page queue, executing the upload procedure.

7. The data uploading method according to claim 6, wherein the upload procedure further comprises:
when the first authorization remaining size is equal to zero or less than the data size, uploading the packet data stored in the upload queue through the network device.

8. The data uploading method according to claim 7, wherein the upload procedure further comprises:
when the second authorization remaining size is equal to zero or less than the data size, uploading the packet data stored in the upload queue through the network device.

9. The data uploading method according to claim 8, wherein the remaining queue upload procedure further comprises:
when the first authorization remaining size is less than the remainder parameter, setting the second upload size as zero.

10. The data uploading method according to claim 9, wherein the upload procedure further comprises:
when the first stop condition is met, updating the start page number according to the page record that follows the last page record in the first summation result.

11. The data uploading method according to claim 10, wherein each page record further comprises a page full flag, wherein the upload procedure further comprises:
when the first stop condition is met and the first authorization remaining size is greater than the data size, setting the page full flag of the page record that follows the last page record in the first summation result as a non-full value.

12. The data uploading method according to claim 11, the upload procedure further comprising:
when the second stop condition is met, updating the start packet number according to the packet that follows the last packet in the second summation result.

13. The data uploading method according to claim 12, wherein the upload procedure further comprises:
when the page full flag of the page record corresponding to the start page number is a non-full value, storing data of the packet corresponding to the start packet number of the page record corresponding to the start page number and the continuation packets thereof to the upload queue one by one, and summing the data sizes of the packet corresponding to the start packet number of the page record corresponding to the start page number and the continuation packets thereof to calculate a third summation result, and updating the start page number according to the page record that follows the page record corresponding to the start page number;
storing data of the packets corresponding to the page record corresponding to the start page number and the continuation page records thereof to the upload queue page by page, and summing the page sizes of the page record corresponding to the start page number and the continuation page records thereof to calculate the first summation result, and determining whether the first summation result meets a third stop condition or not after working out the first summation result page by page each time, wherein the third stop condition is that the authorization size minus the first summation result and the third summation result is less than the page size; and
when the third stop condition is met, taking the first summation result plus the third summation result as the first upload size, and subtracting the first upload size from the authorization size to obtain the first authorization remaining size.

14. The data uploading method according to claim 13, wherein the upload procedure further comprises:
when the third stop condition is met, updating the start page number according to the page record that follows the last page record in the first summation result.

15. The data uploading method according to claim 14, wherein the upload procedure further comprises:
when the third stop condition is met and the first authorization remaining size is greater than zero, setting the page full flag of the page record that follows the last page record in the first summation result as a non-full value.

16. The data uploading method according to claim 2, wherein the remaining queue upload procedure comprises:
subtracting the first authorization remaining size divided by the data size from the first authorization remaining size to obtain a second upload size;
storing data of part of packets corresponding to the page record corresponding to the continuation page number to the upload queue according to the continuation page number and the second upload size, wherein a sum of data sizes of the part of packets corresponding to the page record corresponding to the continuation page number stored to the upload queue is equal to the second upload size; and
uploading data of the packets corresponding to all the page records in the page queue through the network device.

17. A network device coupled to an optical line terminal and a user terminal device, comprising:
a first output/input port coupled to the optical line terminal;
a controller, comprising a page queue, the page queue comprises multiple sequential page records, and each page record comprises a page size and an auxiliary queue, wherein the auxiliary queue comprises multiple sequential packets corresponding to the page record, and the page size is a sum of data sizes of the packets corresponding to the page record, the controller being configured to execute a data uploading method, the data uploading method comprising:
receiving an authorization message from the optical line terminal through the first output/input port, the authorization message comprising an authorization size;
executing an upload procedure to obtain an upload queue, the upload procedure comprising:
executing a page queue upload procedure according to the page queue and the authorization size to obtain a first authorization remaining size and a continuation page number;
executing a remaining queue upload procedure according to the first authorization remaining size, the continuation page number and a remainder parameter to obtain a continuation packet number and a second authorization remaining size; and
executing a packet upload procedure according to the continuation packet number and the second authorization remaining size; and
uploading packet data stored in the upload queue to the optical line terminal through the first output/input port;
a buffer coupled to the controller, the buffer configured to store the data of the packets corresponding to the multiple page records; and
a second output/input port coupled to the user terminal device, the second output/input port configured to receive the data of the packets corresponding to the multiple page records from the user terminal device.

18. The network device according to claim 17, wherein the page queue upload procedure comprises:
obtaining a start page number according to the page queue, the start page number corresponds to one of the page records;
storing data of the packets corresponding to the page record corresponding to the start page number and the continuation page records thereof to the upload queue page by page, and summing the page sizes of the page record corresponding to the start page number and the continuation page records thereof to calculate a first summation result, and determining whether the first summation result meets a first stop condition or not after working out the first summation result page by page each time, wherein the first stop condition is that the authorization size minus the first summation result is less than the page size;
when the first stop condition is met, taking the first summation result as a first upload size, and subtracting the first upload size from the authorization size to obtain a first authorization remaining size; and
obtaining the continuation page number according to the page record that follows the last page record in the first summation result.

19. The network device according to claim 18, wherein the remaining queue upload procedure comprises:
subtracting a remainder derived from the first authorization remaining size divided by the remainder parameter from the first authorization remaining size to obtain a second upload size;
storing data of part of packets corresponding to the page record corresponding to the continuation page number to the upload queue according to the continuation page number and the second upload size, wherein a sum of data sizes of the part of packets corresponding to the page record corresponding to the continuation page number stored to the upload queue is equal to the second upload size;
obtaining a start packet number according to the auxiliary queue of the page record corresponding to the continuation page number, the start packet number corresponding to one of the packets, and each packet comprising the data size of the packet;
obtaining the continuation packet number according to the start packet number and the second upload size, the continuation packet number corresponding to one of the packets; and
subtracting the second upload size from the first authorization remaining size to obtain the second authorization remaining size.

20. The network device according to claim 19, wherein the packet upload procedure comprises:
storing data of the packet corresponding to the continuation packet number and the continuation packets thereof to the upload queue one by one, and summing the data sizes of the packet corresponding to the continuation packet number and the continuation packets thereof to calculate a second summation result, and determining whether the second summation result meets a second stop condition or not after working out the second summation result one by one, wherein the second stop condition is that the second authorization remaining size minus the second summation result is less than the data size.

21. The network device according to claim 20, wherein the data uploading method further comprises:
after receiving the authorization message, determining whether the authorization size is greater than or equal to a sum of the page sizes of all the page records in the page queue or not; and
when the authorization size is greater than or equal to a sum of the page sizes of all the page records in the page queue, uploading data of the packets corresponding to all the page records in the page queue.

22. The network device according to claim 21, further comprising:
when the authorization size is less than the sum of the page sizes of all the page records in the page queue, executing the upload procedure.

23. The network device according to claim 22, wherein the upload procedure further comprises:
when the first authorization remaining size is equal to zero or less than the data size, uploading the packet data stored in the upload queue.

24. The network device according to claim 23, wherein the upload procedure further comprises:
when the second authorization remaining size is equal to zero or less than the data size, uploading the packet data stored in the upload queue.

25. The network device according to claim 24, wherein the remaining queue upload procedure further comprises:
when the first authorization remaining size is less than the remainder parameter, setting the second upload size as zero.

26. The network device according to claim 25, wherein the upload procedure further comprises:
when the first stop condition is met, updating the start page number according to the page record that follows the last page record in the first summation result.

27. The network device according to claim 26, wherein each page record further comprises a page full flag, wherein the upload procedure further comprises:
when the first stop condition is met and the first authorization remaining size is greater than the data size, setting the page full flag of the page record that follows the last page record in the first summation result as a non-full value.

28. The network device according to claim 27, the upload procedure further comprising:
when the second stop condition is met, updating the start packet number according to the packet that follows the last packet in the second summation result.

29. The network device according to claim 28, wherein the upload procedure further comprises:
when the page full flag of the page record corresponding to the start page number is a non-full value, storing data of the packet corresponding to the start packet number of the page record corresponding to the start page number and the continuation packets thereof to the upload queue one by one, and summing the data sizes of the packet corresponding to the start packet number of the page record corresponding to the start page number and the continuation packets thereof to calculate a third summation result, and updating the start page number according to the page record that follows the page record corresponding to the start page number;
storing data of the packets corresponding to the page record corresponding to the start page number and the continuation page records thereof to the upload queue page by page, and summing the page sizes of the page record corresponding to the start page number and the continuation page records thereof to calculate the first summation result, and determining whether the first summation result meets a third stop condition or not after working out the first summation result page by page each time, wherein the third stop condition is that the authorization size minus the first summation result and the third summation result is less than the page size; and
when the third stop condition is met, taking the first summation result plus the third summation result as the first upload size, and subtracting the first upload size from the authorization size to obtain the first authorization remaining size.

30. The network device according to claim 29, wherein the upload procedure further comprises:
when the third stop condition is met, updating the start page number according to the page record that follows the last page record in the first summation result.

31. The network device according to claim 30, wherein the upload procedure further comprises:
when the third stop condition is met and the first authorization remaining size is greater than zero, setting the page full flag of the page record that follows the last page record in the first summation result as a non-full value.

32. The network device according to claim 18, wherein the remaining queue upload procedure comprises:
subtracting the first authorization remaining size divided by the data size from the first authorization remaining size to obtain a second upload size;
storing data of part of packets corresponding to the page record corresponding to the continuation page number to the upload queue according to the continuation page number and the second upload size, wherein a sum of data sizes of the part of packets corresponding to the page record corresponding to the continuation page number stored to the upload queue is equal to the second upload size; and
uploading the data of the packets corresponding to all the page records in the page queue.
